(19) United States
(12) Patent Application Publication
(10) Pub. No.: US 2018/0220058 A1
(43) Pub. Date: Aug. 2, 2018

(54) IMAGE CAPTURE APPARATUS, CONTROL METHOD THEREFOR, AND COMPUTER-READABLE MEDIUM

(71) Applicant: CANON KABUSHIKI KAISHA, Tokyo (JP)

(72) Inventor: Hayato Takahashi, Yokohama-shi (JP)

(21) Appl. No.: 15/883,506

(22) Filed: Jan. 30, 2018

(30) Foreign Application Priority Data
Feb. 1, 2017 (JP) 2017-016977

(51) Int. Cl. H04N 5/232; G02B 7/36; H04N 5/374

(52) U.S. Cl. CPC H04N 5/23212; H04N 5/374; G02B 7/365

(57) ABSTRACT

An image capture apparatus uses an image sensor that includes pixels for focus-detection that double as pixels for image-capturing. After signals of pixels used as the pixels for focus-detection are read out, signals of pixels used as the pixels for image-capturing are read out. Furthermore, signals for a captured image that have been generated from the signals of the pixels used as the pixels for focus-detection, as well as signals that have been read out from the pixels used as the pixels for image-capturing, are rearranged into the order that is the same as the arrangement of pixels in the image sensor. Both the acceleration in focus detection processing and the generation of a captured image with high image quality can be achieved.

### BACKGROUND OF THE INVENTION

### Field of the Invention

The present invention relates to an image capture apparatus, a control method therefor, and a computer-readable medium.

### Description of the Related Art

Automatic focus detection (AF) executed on digital (video) cameras and the like is broadly classified into a contrast detection type and a phase-difference detection type. Conventionally, AF of the phase-difference detection type requires a dedicated sensor to generate image signals for phase-difference detection. However, in recent years, a technique to generate image signals for phase-difference detection with the aid of an image sensor used in shooting has been realized and widely used (Japanese Patent Laid-Open No. 2010-219958). AF of the phase-difference detection type based on output signals of an image sensor is also referred to as an imaging plane phase-difference detection type in distinction from a configuration that uses a dedicated sensor.

An image sensor used in AF of the imaging plane phase-difference detection type includes pixels for generating image signals for phase-difference detection (pixels for focus-detection). It is also known that readout is executed separately from the pixels for focus-detection and normal pixels (pixels for image-capturing) as described in Japanese Patent Laid-Open No. 2010-219958 due to, for example, the difference between the intended uses of output signals of the pixels for focus-detection and normal pixels.

In order to execute AF of the imaging plane phase-difference detection type, it is necessary to read out signals of the pixels for focus-detection from the image sensor; by reading out signals of the pixels for focus-detection before signals of the pixels for image-capturing, AF processing can be started promptly. In the case of pixels for focus-detection of a dedicated type that cannot be used as normal pixels (pixels for image-capturing), like the ones described in Japanese Patent Laid-Open No. 2010-219958, generating a captured image using only signals of the pixels for image-capturing, which are read out later, does not raise major problems.

On the other hand, in the case of pixels for focus-detection of a dual-purpose type that can also be used as pixels for image-capturing, a captured image with high image quality can be generated when signals of the pixels for focus-detection are used in the generation of the captured image. However, if the captured image is generated using pixel signals in the readout order, pixel signals corresponding to the positions of the pixels for focus-detection, which have been read out first, are placed first, thereby exhibiting a difference in a pixel arrangement compared to the original captured image.

### SUMMARY OF THE INVENTION

The present invention has been made in view of the foregoing issues. The present invention relates to an image capture apparatus that uses an image sensor including pixels for focus-detection that double as pixels for image-capturing, and to a control method therefor, and makes it possible to achieve, for example, both the acceleration in focus detection processing and the generation of a captured image with high image quality.

According to an aspect of the present invention, there is provided an image capture apparatus, comprising: an image sensor including a plurality of pixels that are usable both as pixels for image-capturing and pixels for focus-detection; a readout unit configured to read out signals of pixels used as the pixels for focus-detection and then reading out signals of pixels used as the pixels for image-capturing from among the plurality of pixels; and a rearrangement unit configured to rearrange signals for a captured image that have been generated from the signals of the pixels used as the pixels for focus-detection, as well as signals that have been read out from the pixels used as the pixels for image-capturing, into an order that is the same as an arrangement of the pixels in the image sensor.

According to another aspect of the present invention, there is provided a control method for an image capture apparatus having an image sensor including a plurality of pixels that are usable both as pixels for image-capturing and pixels for focus-detection, the control method comprising: reading out signals of pixels used as the pixels for focus-detection from among the plurality of pixels; reading out signals of pixels used as the pixels for image-capturing after reading out the signals of the pixels used as the pixels for focus-detection; and rearranging signals for a captured image that have been generated from the signals of the pixels used as the pixels for focus-detection, as well as signals that have been read out from the pixels used as the pixels for image-capturing, into an order that is the same as an arrangement of the pixels in the image sensor.

According to a further aspect of the present invention, there is provided a computer-readable medium having stored therein a program that causes a computer included in an image capture apparatus that comprises an image sensor including a plurality of pixels that are usable both as pixels for image-capturing and pixels for focus-detection to function as: a readout unit configured to read out signals of pixels used as the pixels for focus-detection and then reading out signals of pixels used as the pixels for image-capturing from among the plurality of pixels; and a rearrangement unit configured to rearrange signals for a captured image that have been generated from the signals of the pixels used as the pixels for focus-detection, as well as signals that have been read out from the pixels used as the pixels for image-capturing, into an order that is the same as an arrangement of the pixels in the image sensor.

Further features of the present invention will become apparent from the following description of exemplary embodiments with reference to the attached drawings.

### BRIEF DESCRIPTION OF THE DRAWINGS

FIG. 1 is a diagram showing a configuration of an image capture apparatus according to an embodiment.

FIGS. 2A to 2C are diagrams related to an image sensor included in the image capture apparatus according to an embodiment.

FIG. 3 is an exemplary equivalent circuit diagram for the image sensor included in the image capture apparatus according to an embodiment.

FIGS. 4A and 4B are timing charts showing examples of a readout operation of the image sensor according to an embodiment.

FIG. 5 is a diagram schematically showing a flow of signals of the image capture apparatus according to a first embodiment.

FIG. 6 is a timing chart for the image capture apparatus according to the first embodiment.

FIG. 7 is a flowchart for the image capture apparatus according to the first embodiment.

FIG. 8 is a diagram schematically showing a flow of signals of the image capture apparatus according to a second embodiment.

FIG. 9 is a timing chart for the image capture apparatus according to the second embodiment.

FIG. 10 is a flowchart for the image capture apparatus according to the second embodiment.

FIG. 11 is a diagram schematically showing a flow of signals of the image capture apparatus according to a third embodiment.

FIG. 12 is a timing chart for the image capture apparatus according to the third embodiment.

FIG. 13 is a flowchart for the image capture apparatus according to the third embodiment.

### DESCRIPTION OF THE EMBODIMENTS

Exemplary embodiments of the present invention will now be described in detail in accordance with the accompanying drawings. The present invention is applicable to any image capture apparatus that can use an image sensor including pixels for focus-detection that can double as a captured image. Note that image capture apparatuses include not only image capture apparatuses with built-in lenses and so-called mirrorless interchangeable-lens image capture apparatuses, but also electronic devices with an image capture function. Such electronic devices include, but are not limited to, smartphones, personal computers, tablet terminals, game devices, etc.

### First Embodiment

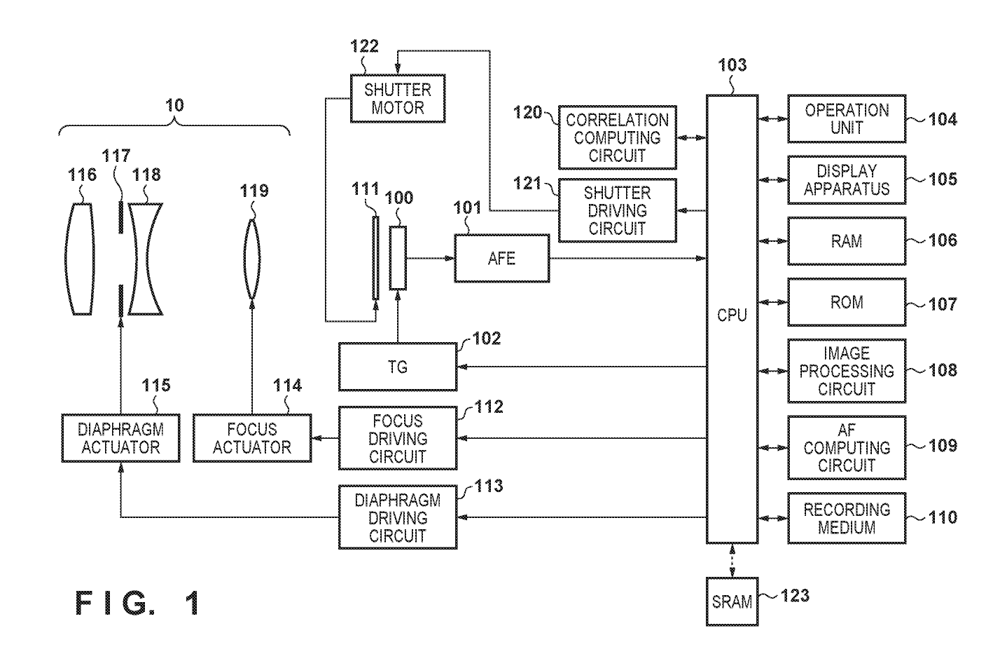

FIG. 1 is a block diagram showing an exemplary functional configuration of an image capture apparatus 1 according to a first embodiment of the present invention. Note that function blocks that are described as “circuits” in FIG. 1 may each be constituted by independent hardware (e.g., an ASIC or ASSP), or a plurality of such function blocks may be constituted by one item of hardware. An image sensor 100 is, for example, a CCD or CMOS image sensor, and photoelectrically converts an optical image of a subject formed by an imaging optical system 10 into an electrical signal. As will be described later, the image sensor 100 includes a plurality of pixels that are placed two-dimensionally, and each pixel is configured to be usable both as a pixel for image-capturing and as a pixel for focus-detection. In the following description, the pixels will be referred to as pixels for image-capturing or pixels for focus-detection depending on the intended use of the pixels.

The operations (accumulation, resetting, readout, etc.) of the image sensor 100 are controlled by various types of signals generated by a timing generator (TG) 102 under control of a central processing unit (CPU) 103. An analog front-end (AFE) 101 applies gain adjustment, A/D conversion, and the like to an analog image signal that has been read out from the image sensor 100. The TG 102 controls the operations of the image sensor 100 and the AFE 101 under control of the CPU 103. Although the AFE 101 and the TG 102 are illustrated as components that are separate from the image sensor 100 in FIG. 1, they may be configured to be embedded in the image sensor 100.

As described above, the CPU 103 controls various components of the image capture apparatus and realizes the functions of the image capture apparatus by, for example, reading programs stored in a ROM 107 into a RAM 106 and executing the programs. Note that at least a part of function blocks that will be described below as circuits may be realized by the CPU 103 executing programs, rather than being realized by such hardware as an ASIC or ASSP.

An operation unit 104 is a group of input devices including a touchscreen, keys, buttons, and the like, and is used by a user to input instructions, parameters, and the like to the image capture apparatus. The operation unit 104 includes a release button, a power switch, directional keys, a menu button, a determination (set) button, a shooting mode dial, a moving image shooting button, and the like; note that these are merely examples. Furthermore, in some cases, the touchscreen is built in a display apparatus 105. The CPU 103 monitors the operation unit 104, and upon detection of an operation performed on the operation unit 104, executes an operation corresponding to the detected operation.

The display apparatus 105 displays shot images (still images and moving images), a menu screen, settings values and states of the image capture apparatus 1, and the like under control of the CPU 103.

The RAM 106 is used to store image data output from the AFE 101 and image data processed by an image processing circuit 108, and is used as a working memory for the CPU 103. In the present embodiment, it will be assumed that the RAM 106 is constituted by a DRAM; however, no limitation is intended in this regard.

The ROM 107 stores programs executed by the CPU 103, various types of setting values, GUI data, etc. At least a part of the ROM 107 may be rewritable.

The image processing circuit 108 applies various types of image processing to image data. Image processing includes processing related to recording and reproduction of shot images, such as color interpolation, white balance adjustment, optical distortion correction, tone correction, encoding, and decoding. Image processing also includes processing related to control over a shooting operation, such as calculation of evaluation values for contrast AF, generation of image signals for imaging plane phase-difference AF, generation of luminance evaluation values for AE, detection of a subject, and detection of motion vectors. Note that the types of image processing listed above are merely examples, and the execution thereof is not intended to be essential. Furthermore, other image processing may be executed.

A correlation computing circuit 120 executes correlation computing with respect to image signals for imaging plane phase-difference AF generated by the image processing circuit 108, and calculates a phase difference (a magnitude and a direction) between the image signals.

An AF computing circuit 109 calculates a driving direction and a driving amount of a focusing lens 119 based on a correlation computation result output from the correlation computing circuit 120. A recording medium 110 is used when shot image data is to be recorded into the image capture apparatus 1. The recording medium 110 may be, for example, an attachable and removable memory card and/or an embedded fixed memory.

A shutter 111 is a mechanical shutter for adjusting an exposure period of the image sensor 100 during still image shooting, and is opened and closed by a motor 122. The CPU 103 controls such opening and closing performed by the motor 122 via a shutter driving circuit 121. Note that instead of using the mechanical shutter, a charge accumulation period of the image sensor 100 may be adjusted using a signal supplied from the TG 102 (an electronic shutter).

A focus driving circuit 112 moves the focusing lens 119 in an optical axis direction by driving a focus actuator 114 to change a focal length of the imaging optical system. In executing imaging plane phase-difference AF, the focus actuator 114 is driven based on a driving direction and a driving amount of the focusing lens 119 calculated by the AF computing circuit 109.

A diaphragm driving circuit 113 changes an aperture diameter of a diaphragm 117 by driving a diaphragm actuator 115. A lens 116 is placed at the tip of the imaging optical system, and is held in such a manner that it can reciprocate in the optical axis direction. The diaphragm 117 and a second lens 118 reciprocate integrally in the optical axis direction, and realize a magnification changing mechanism (a zoom function) in coordination with the reciprocal motion of the foregoing first lens 116.

An SRAM 123 is a memory used in a third embodiment, and reading and writing are executable at higher speed with it than with the RAM 106.

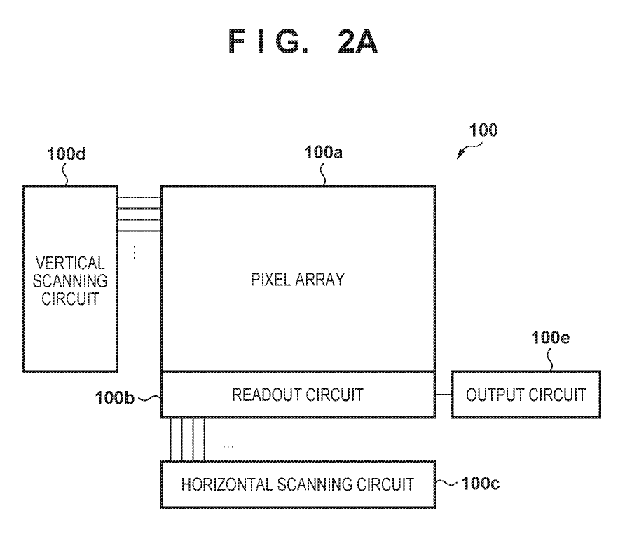

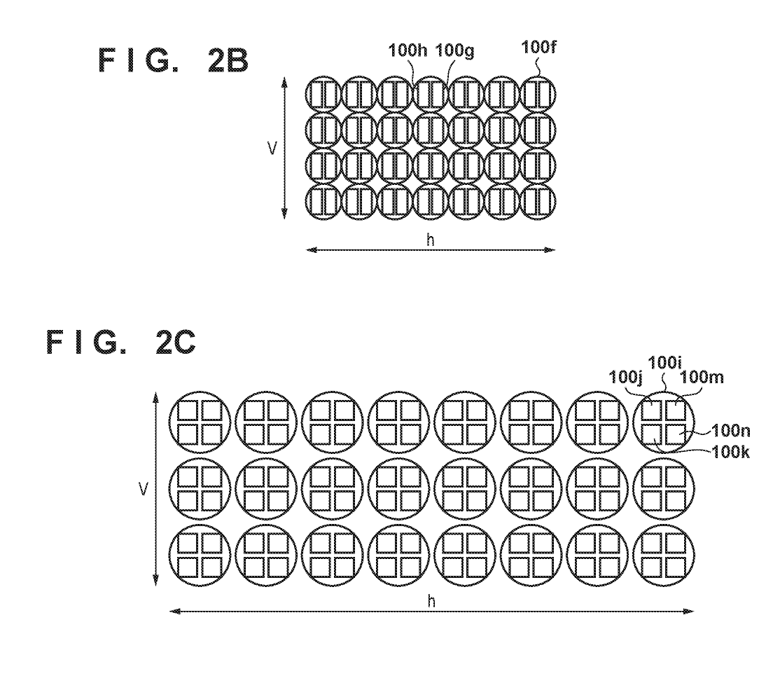

FIG. 2A schematically shows an exemplary configuration of the image sensor 100. The image sensor 100 includes a pixel array 100a in which a plurality of pixels are arranged two-dimensionally, a vertical scanning circuit 100d that selects a pixel row in the pixel array 100a, and a horizontal scanning circuit 100c that selects a pixel column in the pixel array 100a. The image sensor 100 also includes a readout circuit 100b for reading out signals of pixels selected by the vertical scanning circuit 100d and the horizontal scanning circuit 100c. The vertical scanning circuit 100d activates a readout pulse, which is supplied from the TG 102 based on a horizontal synchronization signal output from the CPU 103, in a selected pixel row. The readout circuit 100b includes amplifiers and memories that are both provided in one-to-one correspondence with columns, and stores a pixel signal of a scanning row to the memories via the amplifiers. The horizontal scanning circuit 100c sequentially selects, in a column direction, a pixel signal corresponding to one row stored in the memories, and outputs them to the outside via an output circuit 100e. Repeating this operation will output signals of all pixels to the outside.

FIGS. 2B and 2C show examples of a placement of microlenses and photoelectric conversion units in the pixel array 100a of the image sensor 100. The pixel array 100a includes a microlens array composed of a plurality of microlenses 100f. The configuration of the image sensor 100 according to the present embodiment is such that a plurality of photodiodes (PDs) are provided per microlens. FIG. 2B depicts an example in which two PDs are provided per microlens, whereas FIG. 2C depicts an example in which four PDs are provided per microlens. Note that no particular limitation is intended regarding the number of PDs per microlens.

In the exemplary configuration shown in FIG. 2B, a PD 100h constitutes an A-image photoelectric conversion unit, and a PD 100g constitutes a B-image photoelectric conversion unit. Provided that an image capturing region corresponding to one microlens 100f is one pixel, h pixels are placed in a horizontal direction and v pixels are placed in a vertical direction in the pixel array 100a. Signals accumulated in the PDs 100h and the PDs 100g are converted into a voltage signal and output as the aforementioned pixel signal to the outside, either after being summed in a later-described pixel transfer operation or independently. As light beams are made incident on a PD 100h and a PD 100g from different parts of a pupil region corresponding to a microlens 100f, an image signal obtained from a group of signals of the PDs 100h and an image signal obtained from a group of signals of the PDs 100g represent images from different points of view. A driving amount and a driving direction of the focusing lens 119 are obtained by calculating a phase difference between this pair of image signals through the correlation computation executed by the correlation computing circuit 120 and converting the phase difference into a defocus amount in the AF computing circuit 109. Herein, an image signal obtained from a group of PDs 100h is referred to as an A image, an image signal obtained from a group of PDs 100g is referred to as a B image, the PDs 100h are referred to as A-image photoelectric conversion units, and the PDs 100g are referred to as B-image photoelectric conversion units. In FIG. 2B, as the PDs 100h and the PDs 100g are lined up in the horizontal direction, a phase difference in the horizontal direction is obtained from the correlation computation executed with respect to the A image and the B image; however, in a case where the PDs 100h and the PDs 100g are lined up in the vertical direction, a phase difference in the vertical direction is obtained in a similar manner.

In the case of the configuration shown in FIG. 2C, images from different points of view are obtained from a PD 100j, a PD 100k, a PD 100m, and a PD 100n. For example, by summing signals of the PDs 100j and 100k and summing signals of the PDs 100m and 100n, this configuration can be substantially treated as a configuration similar to the configuration shown in FIG. 2B. On the other hand, by summing signals of the PDs 100j and 100m and summing signals of the PDs 100k and 100n, this configuration can be treated similarly to a configuration in which two PDs are provided in the vertical direction.

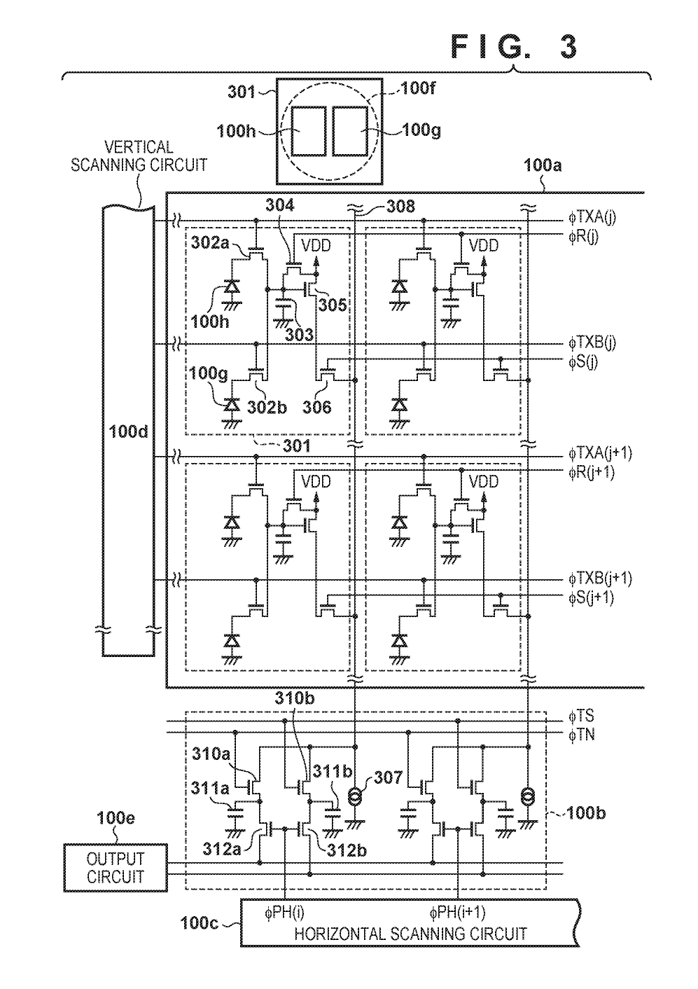

FIG. 3 is an equivalent circuit diagram showing pixels corresponding to two neighboring rows (row j and row (j+1)) and two neighboring columns (column i and column (i+1), among the plurality of pixels provided in the pixel array 100a, as well as a configuration of the readout circuit 100b corresponding to the two columns (column i and column (i+1)).

A control signal ΦTXA(j) and a control signal ΦTXB(j) are respectively input to a transfer switch 302a and a gate of a transfer switch 302b in a pixel 301 in the j^{th} row. A reset switch 304 is controlled by a reset signal ΦR(j). Note that the control signals ΦTXA(j) and ΦTXB(j), the reset signal ΦR(j), and a row selection signal ΦS(j) are controlled by the vertical scanning circuit 100d. Similarly, a pixel 320 in the (j+1)^{th} row is controlled by control signals ΦTXA(j+1) and ΦTXB(j+1), a reset signal ΦR(j+1), and a row selection signal ΦS(j+1).

Furthermore, vertical signal lines 308 are provided in one-to-one correspondence with pixel columns, and each vertical signal line 308 is connected to a current supply 307 and transfer switches 310a, 310b of the readout circuit 100b provided in the corresponding column.

A control signal ΦTN is input to a gate of the transfer switch 310a, and a control signal ΦTS is input to a gate of the transfer switch 310b. Furthermore, a control signal ΦPH(i) output from the horizontal scanning circuit 100c is input to gates of a transfer switch 312a and a transfer switch 312b. An accumulation capacitor unit 311a accumulates the output from the vertical signal line 308 when the transfer switch 310a is in an ON state and the transfer switch 312a is in an OFF state. Similarly, an accumulation capacitor unit 311b accumulates the output from the vertical signal line 308 when the transfer switch 310b is in an ON state and the transfer switch 312b is in an OFF state.

The output from the accumulation capacitor unit 311a and the output from the accumulation capacitor unit 311b are transferred, respectively via separate horizontal output lines, to the output circuit 100e by placing the transfer switch 312a and the transfer switch 312b in the i^{th} column in an ON state using a column selection signal ΦPH(i) from the horizontal scanning circuit 100c.

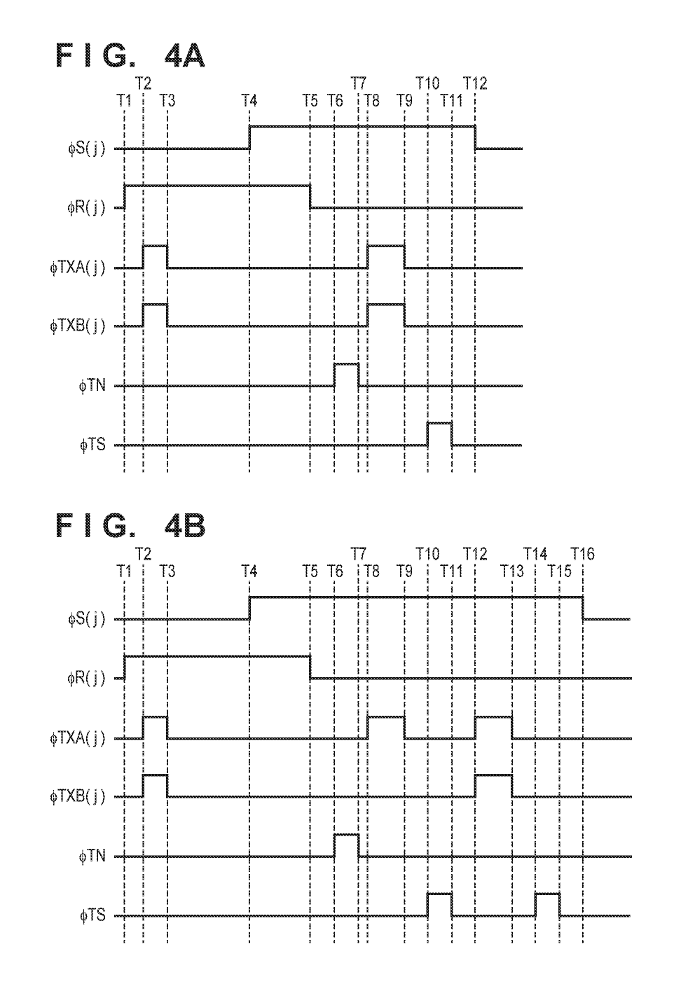

The image sensor 100 configured in the foregoing manner can selectively execute a summation readout operation for reading out a signal obtained by summing signals of a plurality of PDs sharing a microlens, and a division readout operation for obtaining individual signals of PDs. Below, the summation readout operation and the division readout operation will be described with reference to FIGS. 3 to 4B. Note that the description of the present embodiment will be given under the assumption that each switch is turned ON when a corresponding control signal is in an H (high) state, and turned OFF when a corresponding control signal is in an L (low) state.

<Summation Readout Operation>

FIG. 4A shows timings related to an operation of reading out signals from a pixel in the j^{th} row in the image sensor 100 through the summation readout operation. At time T1, the reset signal ΦR(j) is set to H. Next, at time T2, the control signals ΦTXA(j) and ΦTXB(j) are set to H, and PDs 100h, 100g sharing a microlens 100f in the j^{th} row are reset.

Next, the control signals cΦTXA(j) and ΦTXB(j) are set to L at time T3, and then PDs 100h, 100g start the charge accumulation. Subsequently, the row selection signal ΦS(j) is set to H at time T4, and then a row selection switch 306 is placed in an ON state and connected to the vertical signal line 308, and a source follower amplifier 305 is placed in an operating state.

Next, after the reset signal ΦR(j) is set to L at time T5, the control signal ΦTN is set to H at time T6, and then the transfer switch 310a is placed in an ON state and transfers a signal (noise signal) on the vertical signal line 308 after the cancellation of reset to the accumulation capacitor unit 311a.

Next, at time T7, the control signal ΦTN is set to L, and the noise signal is retained in the accumulation capacitor unit 311a. Thereafter, at time T8, the control signals ΦTXA(j) and ΦTXB(j) are set to H, and charges of PDs 100h, 100g are transferred to a floating diffusion region (FD region) 303. At this time, as the charges of the two PDs 100h, 100g are transferred to the same FD region 303, a signal obtained by mixing the charges of the two PDs 100h, 100g (an optical signal+a noise signal corresponding to one pixel) is output to the vertical signal line 308.

Subsequently, at time T9, the control signals ΦTXA(j) and ΦTXB(j) are set to L. Thereafter, the control signal ΦTS is set to H at time T10, and then the transfer switch 310b is placed in an ON state and transfers the signal on the vertical signal line 308 (the optical signal+the noise signal corresponding to one pixel) to the accumulation capacitor unit 311b. Next, at time T11, the control signal ΦTS is set to L, and the optical signal+the noise signal corresponding to one pixel is retained in the accumulation capacitor unit 311b; thereafter, at time T12, the row selection signal ΦS(j) is set to L.

Thereafter, the transfer switches 312a, 312b in the first pixel column through the last pixel column are sequentially placed in an ON state by sequentially setting the column selection signals ΦPH of the horizontal scanning circuit 100c to H. In the foregoing manner, a noise signal of the accumulation capacitor unit 311a and an optical signal+a noise signal corresponding to one pixel of the accumulation capacitor unit 311b are transferred, respectively via different horizontal output lines, to the output circuit 100e. The output circuit 100e calculates a difference between these two horizontal output lines (an optical signal corresponding to one pixel), and outputs a signal obtained by multiplying the difference by a predetermined gain. Hereinafter, a signal obtained through the foregoing summation readout will be referred to as a “first summation signal.”

<Division Readout Operation>

A description is now given of the division readout operation using FIG. 4B. FIG. 4B shows timings related to an operation of reading out signals from a pixel in the j^{th} row in the image sensor 100 through the division readout operation. At time T1, the reset signal OR(j) is set to H. Next, at time T2, ΦTXA(j) and ΦTXB(j) are set to H, and PDs 100h, 100g of a pixel 301 in the j^{th} row are reset. Next, the control signals ΦTXA(j) and ΦTXB(j) are set to L at time T3, and then PDs 100h, 100g start the charge accumulation. Subsequently, the row selection signal (S(j) is set to H at time T4, and then the row selection switch 306 is placed in an ON state and connected to the vertical signal line 308, and the source follower amplifier 305 is placed in an operating state.

After the reset signal ΦR(j) is set to L at time T5, the control signal ΦTN is set to H at time T6, and then the transfer switch 310a is placed in an ON state and transfers a signal (noise signal) on the vertical signal line 308 after the cancellation of reset to the accumulation capacitor unit 311a.

Next, at time T7, the control signal ΦTN is set to L, and the noise signal is retained in the accumulation capacitor unit 311a; thereafter, at time T8, ΦTXA(j) is set to H, and then charges of the PD 100h are transferred to the FD region 303. At this time, as the charges of one of the two PDs 100h, 100g (here, the PD 100h) are transferred to the FD region 303, only a signal corresponding to the charges of the PD 100h is output to the vertical signal line 308.

Next, after the control signal ΦTXA(j) is set to L at time T9, the control signal ΦTS is set to H at time T10, and then the transfer switch 310b is placed in an ON state and transfers the signal on the vertical signal line 308 (an optical signal+a noise signal corresponding to one PD) to the accumulation capacitor unit 311b. Next, at time T11, the control signal ΦTS is set to L.

Thereafter, the transfer switches 312a, 312b in the first pixel column through the last pixel column are sequentially placed in an ON state by sequentially setting the column selection signals ΦPH of the horizontal scanning circuit 100c to H. In the foregoing manner, a noise signal of the accumulation capacitor unit 311a and an optical signal+a noise signal corresponding to one PD of the accumulation capacitor unit 311b are transferred, respectively via separate horizontal output lines, to the output circuit 100e. The output circuit 100e calculates a difference between these two horizontal output lines (an optical signal corresponding to one PD), and outputs a signal obtained by multiplying the difference by a predetermined gain. Hereinafter, a signal obtained through the foregoing readout will be referred to as a “division signal.”

Thereafter, at time T12, ΦTXA(j) and ΦTXB(j) are set to H, and the charges of the PD 100g and the newly generated charges of the PD 100h are further transferred to the FD region 303, in addition to the charges of the PD 100h that were transferred earlier. At this time, as the charges of the two PDs 100h, 100g are transferred to the same FD region 303, a signal obtained by summing the charges of the two PDs 100h, 100g (an optical signal+a noise signal corresponding to one pixel) is output to the vertical signal line 308.

Subsequently, after the control signals ΦTXA(j) and ΦTXB(j) are set to L at time T13, the control signal (TS is set to H at time T14, and then the transfer switch 310b is placed in an ON state. As a result, the signal on the vertical signal line 308 (the optical signal+the noise signal corresponding to one pixel) is transferred to the accumulation capacitor unit 311b.

Next, at time T15, the control signal ΦTS is set to L, and the optical signal+the noise signal corresponding to one pixel is retained in the accumulation capacitor unit 311b; thereafter, at time T16, the row selection signal ΦS(j) is set to L.

Thereafter, the transfer switches 312a, 312b in the first pixel column through the last pixel column are sequentially placed in an ON state by sequentially setting the column selection signals ΦPH of the horizontal scanning circuit 100c to H. In the foregoing manner, noise signals of the accumulation capacitor units 311a, 311b and an optical signal+a noise signal corresponding to one pixel are transferred, respectively via different horizontal output lines, to the output circuit 100e. The output circuit 100e calculates a difference between these two horizontal output lines (an optical signal corresponding to one pixel), and outputs a signal obtained by multiplying the difference by a predetermined gain. Hereinafter, a signal obtained through the foregoing readout will be referred to as a “second summation signal” in distinction from the first summation signal.

By subtracting a division signal corresponding to one PD 100h from the second summation signal that has been read out in the foregoing manner, a division signal corresponding to the other PD 100g can be obtained. The pair of division signals thus obtained will be referred to as “signals for focus-detection.” By executing a known correlation computation with respect to the obtained signals for focus-detection, a phase difference between the signals can be calculated.

Note that after a sequence of operations including resetting, accumulation of charges, and signal readout is executed with respect to the PD 100h, similar operations may be executed with respect to the PD 100g; in this way, signals of the two PDs 100h, 100g are read out independently in connection with a single charge accumulation operation. A second summation signal can be obtained by summing the signals of the PDs 100h, 100g that have been read out in two batches in the foregoing manner. Furthermore, as stated earlier, a configuration in which two PDs are placed per microlens is not exclusive, and signals of a plurality of PDs composed of three or more PDs may be read out in a plurality of batches and composited.

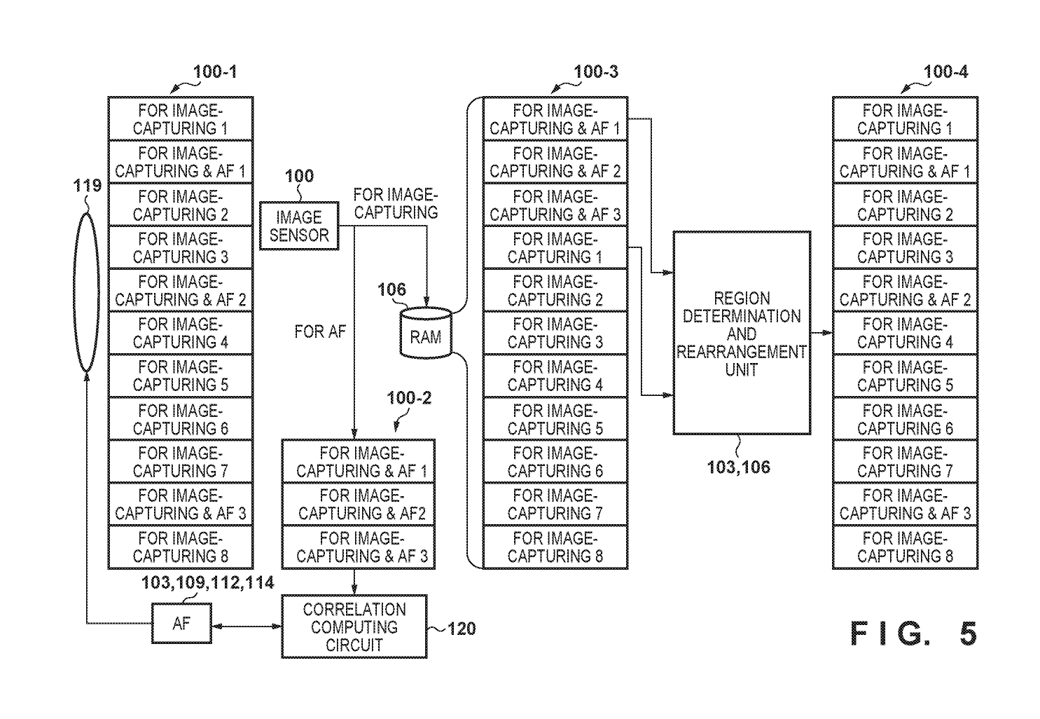

FIG. 5 is a diagram schematically showing a flow of signals associated with the image capture apparatus according to the present embodiment, with a focus on an arrangement of signals that are read out from the image sensor 100.

In FIG. 5, 100-1 schematically depicts an exemplary placement of pixels for image-capturing (for image-capturing) and pixels for focus-detection (for image-capturing & AF) in the pixel array 100a of the image sensor 100. For ease of explanation and comprehension, it will be assumed that pixels for focus-detection are placed in units of readout rows in the present embodiment. However, partial pixels that correspond to a focus detection region in a readout row may be used as pixels for focus-detection, and the rest may be used as pixels for image-capturing. In this case, it is sufficient to execute readout and rearrangement processing, which will be described below, in row blocks that include portions in which pixels for focus-detection are placed.

Note that the following description focuses on portions in which pixels for focus-detection are placed in the pixel array 100a, and it will be assumed that pixels for image-capturing are placed in other regions. Note that as stated earlier, each pixel can be used both as a pixel for focus-detection and a pixel for image-capturing. “Pixels for focus-detection” denote pixels that are used to obtain both signals for focus-detection and signals for a captured image, whereas “pixels for image-capturing” denote pixels that are used only to obtain signals for a captured image. In other words, “pixels for focus-detection” are pixels for which division readout is executed, whereas “pixels for image-capturing” are pixels for which summation readout is executed.

Among pixel signals that have been read out from the image sensor 100, pixel signals supplied to the correlation computing circuit 120 and pixel signals supplied to the RAM 106 are schematically depicted by 100-2 and 100-3, respectively. The image processing circuit 108 generates signals for focus-detection and signals for a captured image from signals of pixels for focus-detection, supplies the signals for focus-detection to the correlation computing circuit 120, and stores the signals for captured image to the RAM 106. Therefore, in the figure, the signals of pixels for focus-detection are included in both of 100-2 and 100-3. Here, as the signals of pixels for focus-detection are read out ahead of signals of pixels for image-capturing, the signals of pixels for focus-detection are placed ahead of the signals of pixels for image-capturing when stored to the RAM 106 first.

A region determination and rearrangement unit schematically represents functions that are realized by the CPU 103 using the RAM 106. Specifically, the region determination and rearrangement unit rearranges pixel signals that are stored in the order of 100-3 inside the RAM 106 into the order of 100-4 (i.e., the arrangement 100-1 in the image sensor 100).

A phase difference that has been computed by the correlation computing circuit 120 with respect to the signals for focus-detection is supplied to an AF processing unit, and the focusing lens 119 is driven accordingly. The AF processing unit schematically represents, as a function block, functions that are realized by the CPU 103, AF computing circuit 109, focus driving circuit 112, and focus actuator 114.

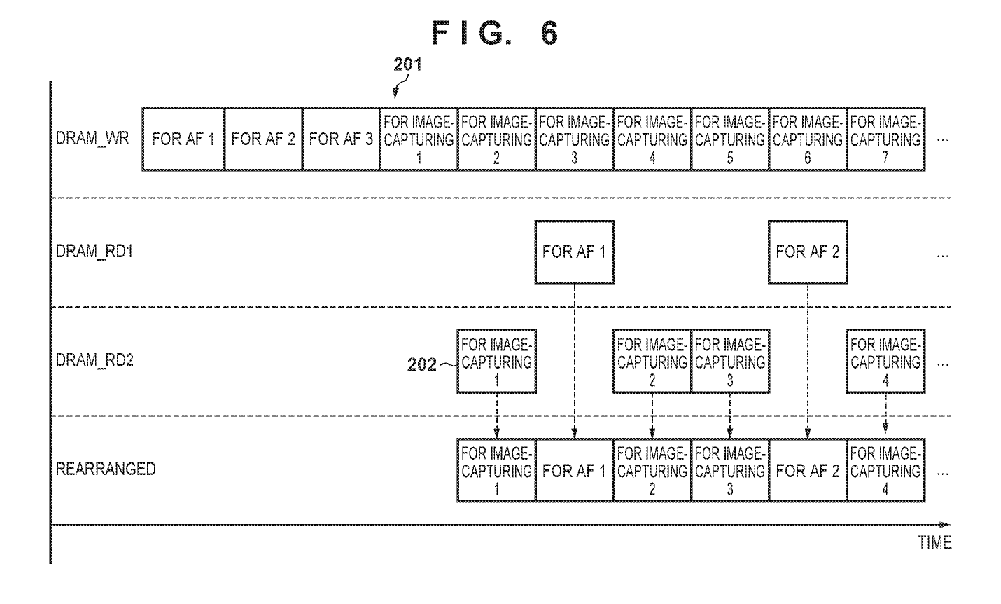

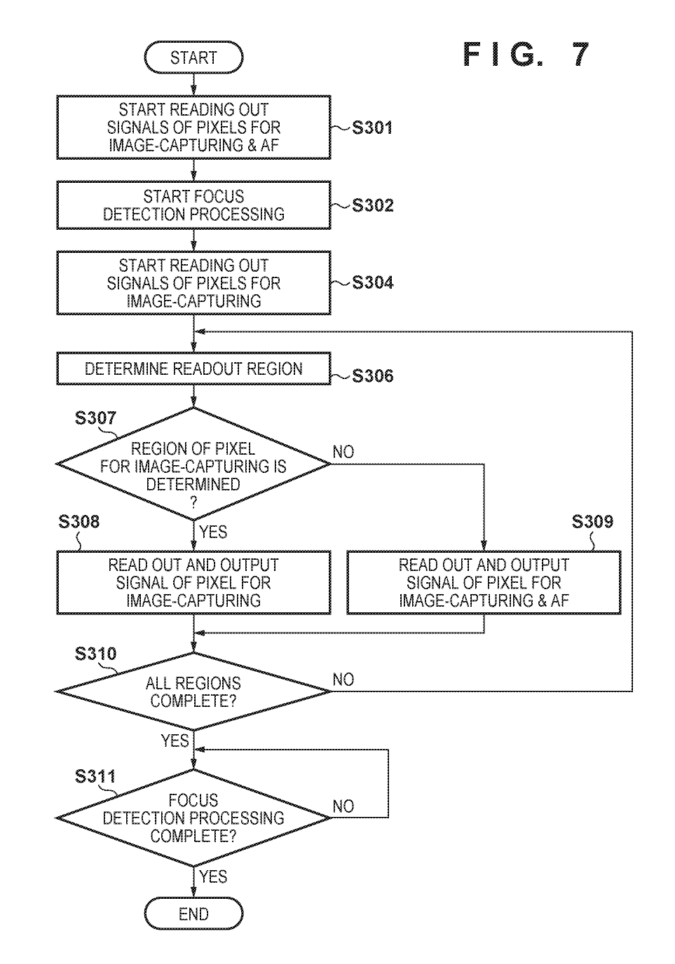

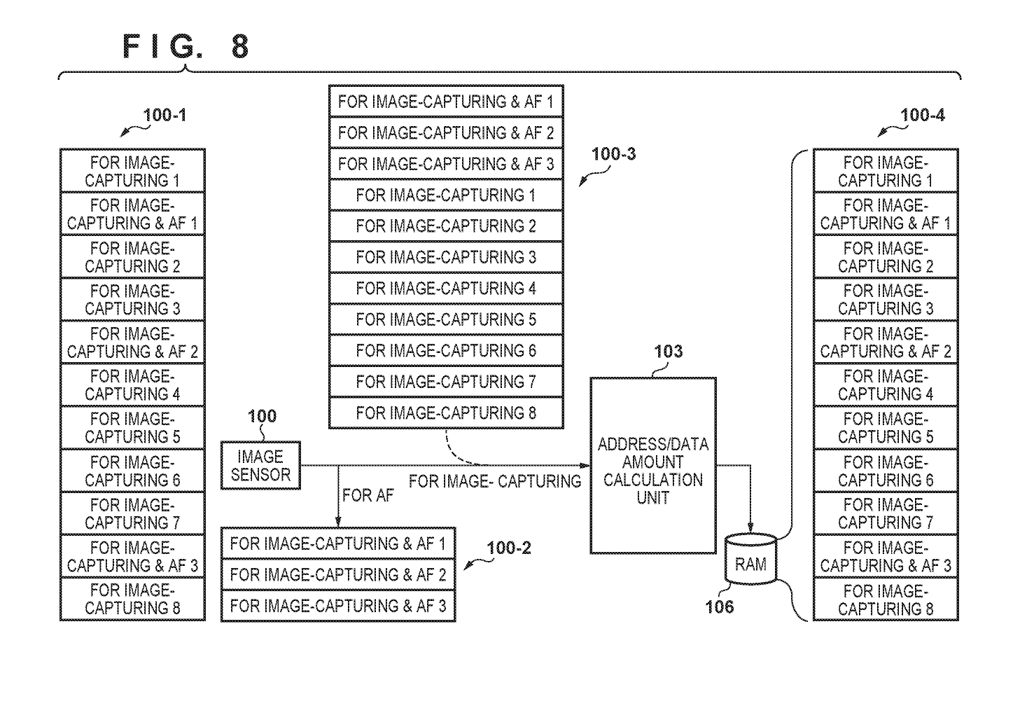

Using a timing chart of FIG. 6 and a flowchart of FIG. 7, the following describes control for readout from the image sensor 100 and a rearrangement operation, which are executed by the CPU 103. It will be assumed that the placement of pixels for focus-detection in the pixel array 100a of the image sensor 100 is set in advance based on, for example, a position of a focus detection region, a result of subject detection, etc. The CPU 103 controls the TG 102 so that the TG 102 supplies, to the image sensor 100, a timing signal for division readout with respect to pixels for focus-detection, and a timing signal for summation readout with respect to pixels for image-capturing.

In step S301, the CPU 103 starts reading out signals of pixels for focus-detection ahead of signals of pixels for image-capturing. The CPU 103 supplies both of second summation signals and division signals that have been obtained through division readout to the image processing circuit 108, and also sequentially writes the second summation signals to a first region in the RAM 106. In FIG. 6, DRAM_WR denotes the order of signals that the CPU 103 writes to the first region in the RAM 106; signals of three rows in which pixels for focus-detection are placed are readout ahead of signals of all pixels for image-capturing, and the second summation signals are written to the RAM 106.

The image processing circuit 108 generates signals for focus-detection from the second summation signals and the division signals supplied from the CPU 103. Here, the image processing circuit 108 can generate the signals for focus-detection only with respect to pixels for which focus detection signals need to be generated (e.g., pixels in a range corresponding to a focus detection region and a predetermined number of pixels that precede and succeed them) among pixels for focus-detection composing each row.

In step S302, the CPU 103 starts focus detection processing by supplying the signals for focus-detection generated by the image processing circuit 108 to the correlation computing circuit 120. Note that the readout processing of step S301 and the focus detection processing of step S302 may be executed in parallel. Once the signals for focus-detection of each row have been supplied, the correlation computing circuit 120 executes a correlation computation with respect to the signals for focus-detection, and calculates a phase difference between an A image and a B image. Note that the correlation computation may be executed with respect to the signals for focus-detection on a row-by-row basis, or may be executed with respect to, for example, a pair of an average waveform of the A image and an average waveform of the B image that have been generated from the signals for focus-detection of a plurality of rows; however, no limitation is intended in this regard.

The CPU 103 supplies the phase difference calculated by the correlation computing circuit 120 to the AF computing circuit 109. The AF computing circuit 109 converts the phase difference into a moving direction and a moving amount of the focusing lens 119, and outputs them to the CPU 103. The CPU 103 drives the focus actuator 114 and moves the focusing lens 119 to an in-focus position by controlling the focus driving circuit 112 in accordance with the moving direction and the moving amount obtained from the AF computing circuit 109.

Meanwhile, upon completion of the readout of the signals of pixels for focus-detection, the CPU 103 starts reading out signals of pixels for image-capturing in step S304. Then, the CPU 103 sequentially writes first summation signals obtained from the pixels for image-capturing to the first region in the RAM 106, following the second summation signals obtained from the pixels for focus-detection. Note that the processing for reading out the pixels for image-capturing in step S304 may be executed in parallel with the focus detection processing of step S302.

Once the readout of the pixels for image-capturing has been started, the CPU 103 starts readout region determination processing of step S306. The readout determination processing is processing for determining a type of a row to be read out from the first region next, in order to rearrange pixel signals that have been read out in the order different from the arrangement of pixels in the image sensor 100 into the order that is the same as the arrangement of pixels in the image sensor 100. Based on the placement of pixels for focus-detection in the pixel array 100a, the CPU 103 determines whether to read out a row with signals of pixels for focus-detection (second summation signals), or to read out a row with signals of pixels for image-capturing (first summation signals).

For example, in an example shown in FIG. 5, pixels for image-capturing, pixels for focus-detection, pixels for image-capturing, pixels for image-capturing, pixels for focus-detection, . . . are placed in this order from the first row of the pixel array 100a. For example, using information of row numbers of rows in which pixels for focus-detection are placed, the CPU 103 can determine whether to read out signals of pixels for image-capturing or to read out signals of pixels for focus-detection, in order from the first row number. In FIG. 6, DRAM_RD1 and DRAM_RD2 respectively depict readout from regions in which signals of pixels for focus-detection are written and readout from regions in which signals of pixels for image-capturing are written in the first region. Furthermore, “rearranged” depicts signals that are written to a second region.

The CPU 103 proceeds to step S308 if it has been determined in step S307 that the row to be read out next corresponds to signals of pixels for image-capturing, and proceeds to step S309 if it has been determined that the row to be read out next corresponds to signals of pixels for focus-detection.

In step S308, the CPU 103 writes a signal of the top row that has not been written to the second region in the RAM 106, among signals of pixels for image-capturing that have been written inside the first region, to the tail of signals that have been written to the second region in the RAM 106.

In step S309, the CPU 103 writes a signal of the top row that has not been written to the second region in the RAM 106, among signals of pixels for focus-detection that have been written inside the first region, to the tail of signals that have been written to the second region in the RAM 106.

In steps S308 and S309, if the second region in the RAM 106 is empty, the CPU 103 executes writing from the top of the second region.

Upon completion of writing corresponding to one row in step S308 or S309, the CPU 103 determines whether there is any signal left that has not been written to the second region in step S310. The CPU 103 proceeds to step S311 if it has been determined that no such signal is left, and returns to step S306 if it has not been determined that no such signal is left.

In step S311, the CPU 103 determines whether the focus detection processing that was started in step S302 has been completed; it ends the processing if it has been determined that the focus detection processing has been completed, and waits for the completion of the focus detection processing if it has not been determined that the focus detection processing has been completed.

Through the foregoing sequence of processing, signals are rearranged into the order depicted by 100-4 of FIG. 5 in the second region in the RAM 106. This order is the same as the order in the pixel array 100a depicted by 100-1. Therefore, with the use of signals in the second region, image processing can be executed without being affected by the change in the order of reading out pixels. It is thus possible to obtain a captured image with high quality compared to, for example, a case where signals that have been stored in the readout order depicted by 100-3 are used, or a case where signals of pixels for focus-detection are not used. Furthermore, as signals of pixels for focus-detection are read out ahead of signals of pixels for image-capturing, a period required for the focus detection processing that uses signals obtained from the image sensor 100 can be reduced.

### Second Embodiment

A second embodiment of the present invention will now be described. In the present embodiment, signal rearrangement is executed without writing signals corresponding to one screen from the image sensor 100 to the RAM 106.

FIG. 8 schematically shows a configuration according to the present embodiment in a form similar to FIG. 5. However, in FIG. 8, the illustration of constituents related to focus detection is omitted. For each of signals that are read out from the image sensor 100 and arranged as indicated by 100-3, the CPU 103 that functions as an address/data amount calculation unit calculates an address with which writing to the RAM 106 is executed, and writes the signal to the calculated address.

In the first embodiment, signals corresponding to one screen are first written to the first region in the RAM 106 in the order in which they were read out, and then rearrangement is executed by controlling the order of transfer or copy from the first region to the second region. On the other hand, in the present embodiment, signal rearrangement is realized by calculating the addresses at which signals that have been read out should be located after the rearrangement, and writing the signals to these addresses.

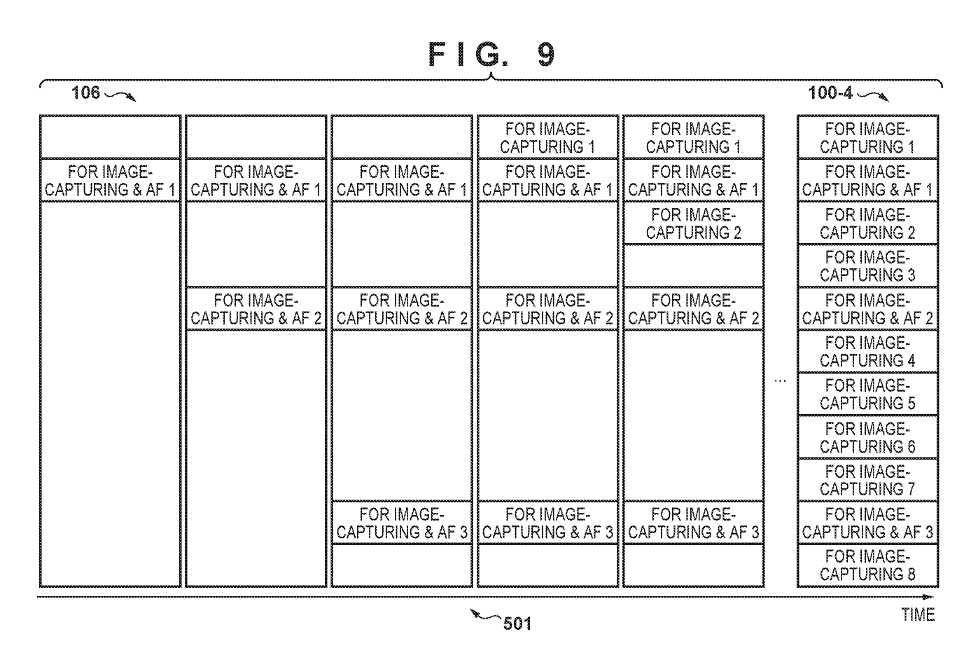

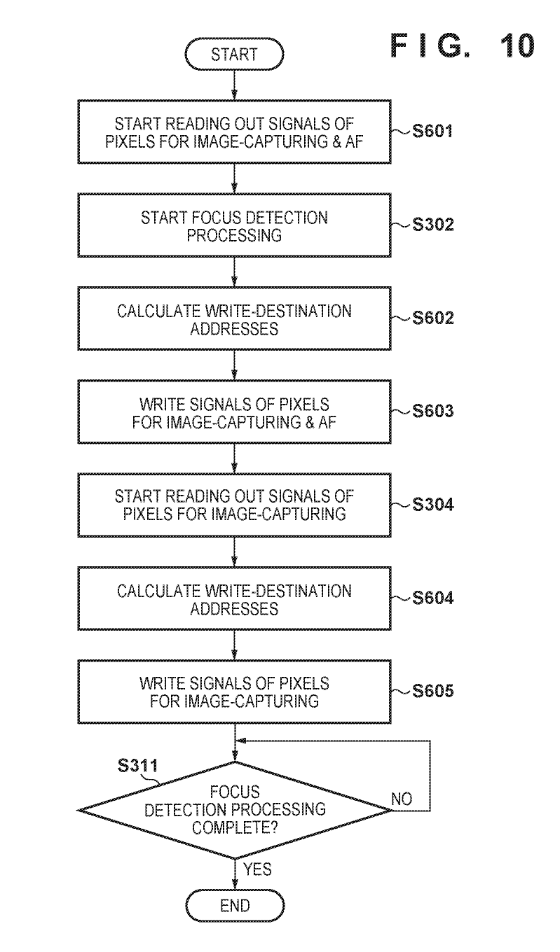

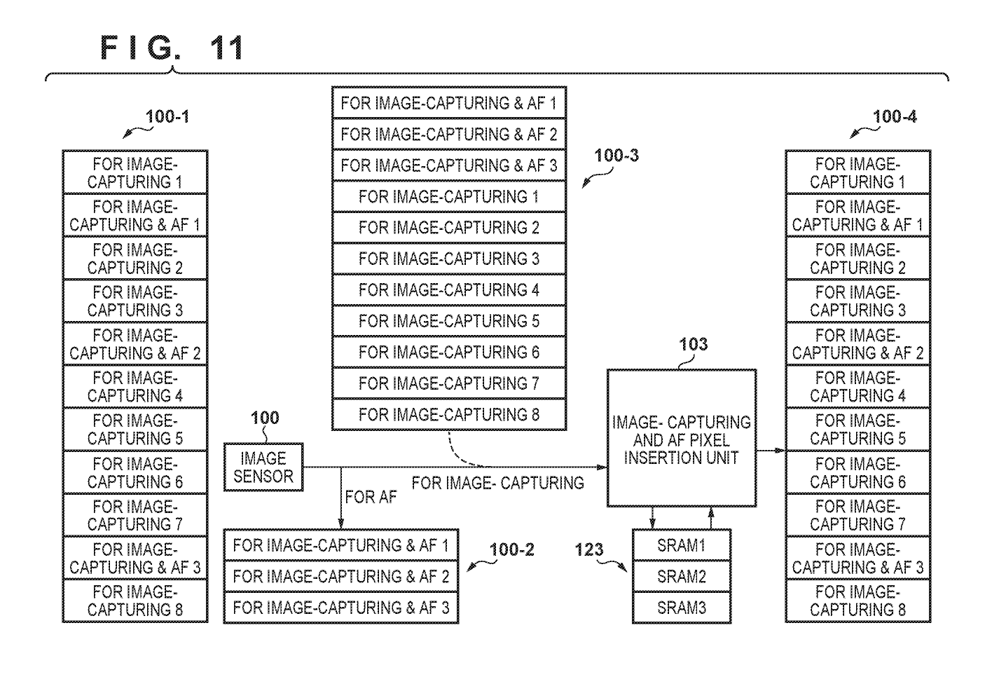

Using FIGS. 9 and 10, the following describes control for readout from the image sensor 100 and a rearrangement operation, which are executed by the CPU 103, in the present embodiment. Note that the control for readout from the image sensor 100 is similar to that according to the first embodiment, and thus a description thereof will be omitted. Furthermore, in FIG. 10, processing that is similar to that according to the first embodiment is given the same reference numeral thereas. FIG. 9 schematically shows the states of the first region in the RAM 106 in chronological order.

In step S601, the CPU 103 starts reading out signals of pixels for focus-detection ahead of signals of pixels for image-capturing. The CPU 103 supplies both of second summation signals and division signals that have been obtained through division readout to the image processing circuit 108. At this point, the CPU 103 does not write the second summation signals to the first region in the RAM 106. The image processing circuit 108 generates signals for focus-detection from the second summation signals and the division signals supplied from the CPU 103.

In step S302, the CPU 103 supplies the signals for focus-detection generated by the image processing circuit 108 to the correlation computing circuit 120. Accordingly, focus detection processing is started.

In step S602, the CPU 103 calculates write addresses of the second summation signals that were read out in step S301. The write addresses can be calculated in accordance with, for example, the positions or order of pixels from which the signals were read out (e.g., the raster scan order in the image sensor).

For example, provided that (i) a data amount per pixel after A/D conversion is n [byte], (ii) the number of pixels per row in the pixel array 100a is m, (iii) a horizontal position of a pixel that has been read out within a row is s (where s is an integer equal to or larger than one), (iv) a row number of a row that has been read out is L (where L is an integer equal to or larger than one, and (v) the top address in the first region in the RAM 106 is 0, a write address can be calculated as follows: a write address [byte]=0+(L−1)*m+(s−1)*n. Note that this calculation method is an example, and other methods may be used.

In step S603, the CPU 103 writes the second summation signals that were read out in step S301 to the addresses in the first region in the RAM 106 that were calculated in step S302. It is assumed here that calculation of and writing to the write addresses are executed on a pixel-by-pixel basis; however, after writing signals corresponding to one row to a buffer region in the RAM 106 in step S301, the top write address in that row may be calculated, and writing to the first region may be executed on a row-by-row basis.

Once the writing of the second summation signals has been completed through the execution of the processing of steps S601, S302, and S602 with respect to signals of all pixels for focus-detection, the first region in the RAM 106 is in a state indicated by 501. Next, in step S304, the CPU 103 starts reading out signals of pixels for image-capturing. Then, in step S604, the CPU 103 calculates write addresses of the signals of pixels for image-capturing, similarly to step S602. In step S605, the CPU 103 writes the signals to the addresses that were calculated in step S604. Once the readout and writing of the signals of pixels for image-capturing have been completed, the signals are in a state where the arrangement thereof matches the arrangement of pixels in the pixel array 100a as indicated by 100-4. The processing of step S311 is similar to that according to the first embodiment.

Advantageous effects that are similar to those achieved by the first embodiment can also be achieved by the present embodiment. Furthermore, with the configuration according to the present embodiment, a period that is required to obtain a post-rearrangement image is short compared to the first embodiment in which the rearrangement is executed after writing signals corresponding to one screen. In addition, a storage capacity required for the rearrangement is small.

### Third Embodiment

A third embodiment of the present invention will now be described. In the present embodiment, signal rearrangement is executed with use of a memory (SRAM 123) with which reading and writing can be executed at high speed compared to the RAM 106 as a storage device (buffer) capable of temporarily storing signals that have been read out, and the signals are written to the first region in the RAM 106. It will be assumed that the SRAM 123 at least has a capacity that can store all of signals of pixels for focus-detection that are read out first.

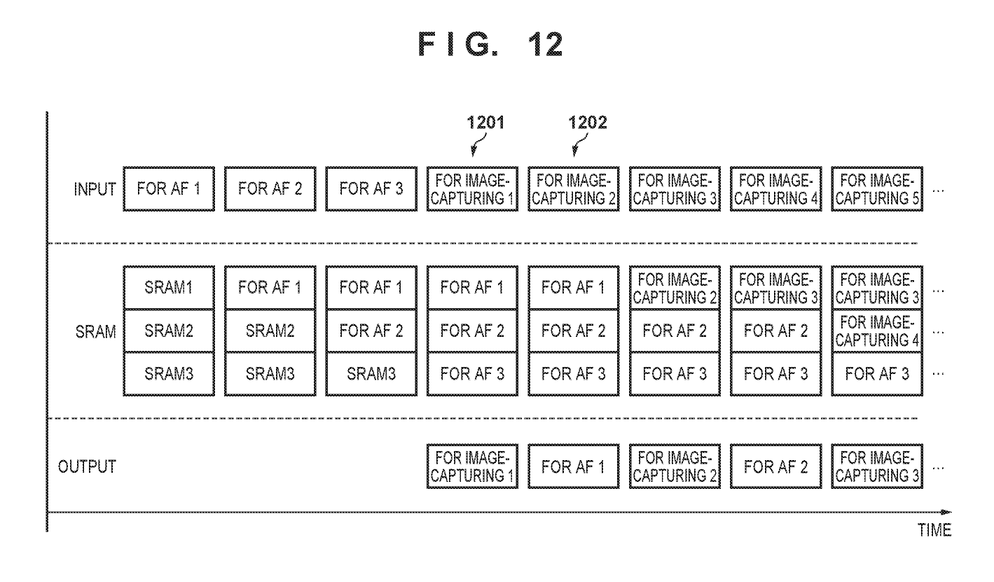

FIG. 11 schematically shows a configuration according to the present embodiment in a form similar to FIG. 5. However, in FIG. 11, the illustration of constituents related to focus detection is omitted. With regard to signals that are read out from the image sensor 100 and arranged as indicated by 100-3, the CPU 103, which serves as a focus-detection pixel signal insertion unit, writes the signals as-is to the first region in the RAM 106 in a case where the signals have been input in the order of writing to the first region. On the other hand, in a case where signals that have been read out from the image sensor 100 are not signals in the order of writing to the first region, the CPU 103 stores them to the SRAM 123. At this time, when the signals in the order of writing to the first region are stored in the SRAM 123, the signals that have been read out from the SRAM are written to the first region.

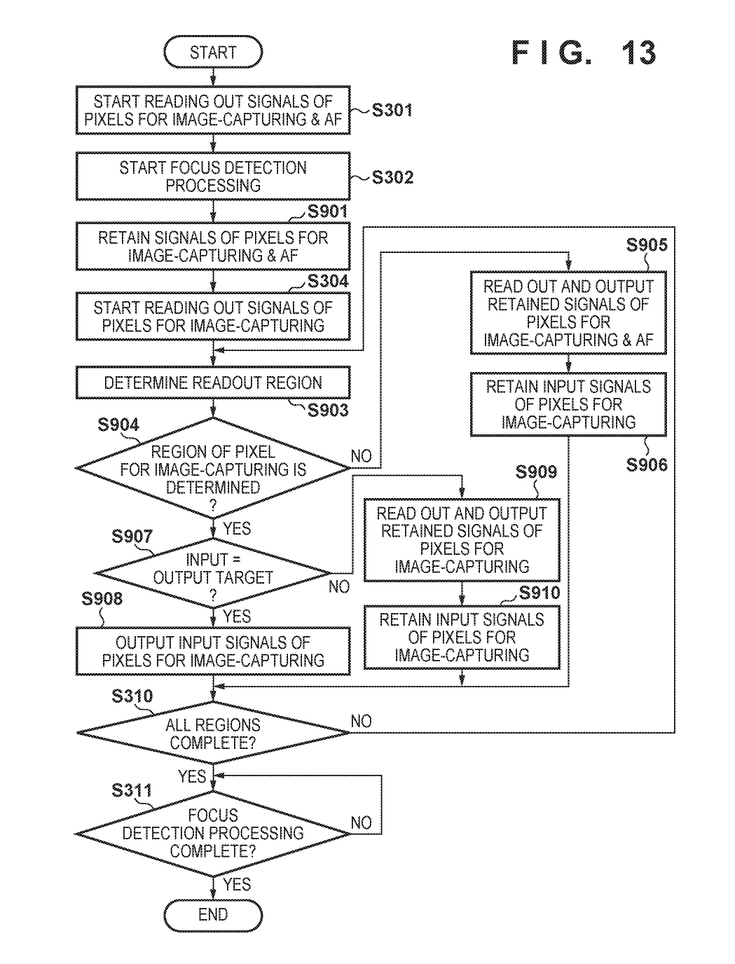

Using FIGS. 12 and 13, the following describes control for readout from the image sensor 100 and a rearrangement operation, which are executed by the CPU 103, in the present embodiment. Note that the control for readout from the image sensor 100 is similar to that according to the first embodiment, and thus a description thereof will be omitted. Furthermore, in FIG. 13, processing that is similar to that according to the first embodiment is given the same reference numeral thereas. FIG. 12 schematically shows the states of pixel signals input to the CPU 103 serving as the focus-detection pixel signal insertion unit, as well as signals written in the SRAM 123 and the first region in the RAM 106 by the CPU 103, in chronological order.

In step S301, the CPU 103 starts reading out signals of pixels for focus-detection ahead of signals of pixels for image-capturing. The CPU 103 supplies both of second summation signals and division signals that have been obtained through division readout to the image processing circuit 108.

In step S302, the CPU 103 supplies signals for focus-detection generated by the image processing circuit 108 to the correlation computing circuit 120. Accordingly, focus detection processing is started.

In step S901, the CPU 103 writes the second summation signals that were read out in step S301 to the SRAM 123. Note that steps S301, S302, and S901 are executed in parallel until all of the signals of pixels for focus-detection are read out.

As the signals of pixels for focus-detection are read out collectively ahead of the signals of pixels for image-capturing, signals corresponding to the first three rows input to the CPU 103 serving as the focus-detection pixel signal insertion unit in FIG. 11 are signals of pixels for focus-detection. Therefore, the CPU 103 sequentially stores the second summation signals corresponding to the three rows to the SRAM 123 as shown in FIG. 12.

Once all of the signals of pixels for focus-detection have been read out, the CPU 103 starts reading out the signals of pixels for image-capturing in step S304, and proceeds to step S903.

In step S903, the CPU 103 makes an output region determination, that is to say, determines a type of signals to be written to the first region in the RAM 106 based on, for example, information related to the placement of pixels for focus-detection. For example, as pixels for image-capturing are placed in the first row of the pixel array 100a, the CPU 103 determines that regions of the pixels for image-capturing are output regions when executing step S903 for the first time.

In step S904, the CPU 103 proceeds to step S907 if it has been determined in step S903 that the output regions are regions of pixels for image-capturing, and to step S905 if it has been determined that the output regions are regions of pixels for focus-detection.

In step S907, the CPU 103 determines whether signals that are currently input (read out) are signals to be output (signals to be written to the first region in the RAM 106 next). This determination may be, for example, a determination about whether a row number of a row that is currently read out matches a row number of a row to be written to the first region in the RAM 106, or may be other determinations.

The CPU 103 proceeds to step S908 if it has been determined that the signals currently input are signals to be output, and to step S909 if it has not been determined that the signals currently input are signals to be output.

In step S908, the CPU 103 sequentially writes the signals currently input to the first region in the RAM 106, and proceeds to step S310.

In step S909, the CPU 103 reads out signals to be output from among the signals of pixels for image-capturing (the first summation signals) stored in the SRAM 123, writes them to the first region in the RAM 106, and proceeds to step S910.

In step S910, the CPU 103 stores the signals of pixels for image-capturing that have been input (read out) in place of the signals that were read out in step S909, and proceeds to step S310. Note that the readout from the SRAM 123 and the writing to the SRAM 123 in steps S909 and S910 may be executed in parallel.

On the other hand, in step S905, the CPU 103 reads out signals to be output from among the signals of pixels for focus-detection (the second summation signals) stored in the SRAM 123, writes them to the first region in the RAM 106, and proceeds to step S906.

In step S906, the CPU 103 stores the signals of pixels for image-capturing that have been input (read out) in place of the signals that were read out in step S905, and proceeds to step S310. Note that the readout from the SRAM 123 and the writing to the SRAM 123 in steps S905 and S906 may be executed in parallel.

The processing of steps S903 to S910 may be executed in units of pixels, or may be executed in units of rows.

In step S310, the CPU 103 determines whether there is any signal left that has not been written to the first region. The CPU 103 proceeds to step S311 if it has been determined that no such signal is left, and returns to step S903 if it has not been determined that no such signal is left.

In step S311, the CPU 103 determines whether the focus detection processing that was started in step S302 has been completed; it ends the processing if it has been determined that the focus detection processing has been completed, and waits for the completion of the focus detection processing if it has not been determined that the focus detection processing has been completed.

In FIG. 12, 1201 depicts a state where signals of pixels for image-capturing in the first row of the pixel array 100a are read out. In this state, as input signals are signals to be output, the second summation signals stored in the SRAM 123 are not read out, and the input signals are output as-is.

In FIG. 12, 1202 depicts a state where signals of pixels for image-capturing in the third row of the pixel array 100a are read out. In the pixel array 100a, pixels for focus-detection are placed in the second row; thus, rather than input signals, signals of pixels for focus-detection (second summation signals) that are stored in the SRAM 123 and have been read out from the second row in the pixel array 100a serve as signals to be output. Therefore, signals that have been read out from the SRAM 123 are output (written) to the RAM 106, and in turn, the signals of pixels for image-capturing in the third row, which are read out, are stored to the SRAM 123.

Thus, with regard to readout of signals of pixels for image-capturing in the eleventh row (for image-capturing 8) and subsequent signals in the pixel array 100a from which all of signals of pixels for focus-detection stored in the SRAM 123 have been output, signals of pixels for image-capturing stored in the SRAM 123 always serve as output targets.

Advantageous effects that are similar to those achieved by the first embodiment and the second embodiment can also be achieved by the present embodiment. Furthermore, the configuration according to the present embodiment enables writing to consecutive addresses in the RAM 106, thereby reducing a period required in the rearrangement compared to the second embodiment. As a memory that is higher in speed than the RAM 106 is used as a memory for temporarily storing signals, a further time reduction is expected.

### Other Embodiments

The processing steps that are shown in the flowcharts of FIGS. 7, 10, and 13 in connection with the foregoing first to third embodiments need not necessarily be executed step-by-step, and two or more consecutive processing steps can be executed in parallel. It should be noted that especially the readout, writing processing, and focus detection processing can each be executed in parallel.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-016977, filed on Feb. 1, 2017, which is hereby incorporated by reference herein in its entirety.

What is claimed is:

1. An image capture apparatus, comprising:
an image sensor including a plurality of pixels that are usable both as pixels for image-capturing and pixels for focus-detection;
a readout unit configured to read out signals of pixels used as the pixels for focus-detection and then reading out signals of pixels used as the pixels for image-capturing from among the plurality of pixels; and
a rearrangement unit configured to rearrange signals for a captured image that have been generated from the signals of the pixels used as the pixels for focus-detection, as well as signals that have been read out from the pixels used as the pixels for image-capturing, into an order that is the same as an arrangement of the pixels in the image sensor.

2. The image capture apparatus according to claim 1, wherein
the rearrangement unit executes the rearrangement within a memory after signals corresponding to one screen are written in the memory.

3. The image capture apparatus according to claim 1, wherein
the rearrangement unit executes the rearrangement by obtaining write addresses corresponding to positions or an order of pixels from which signals have been read out, and writing the signals to the write addresses in a memory.

4. The image capture apparatus according to claim 1, wherein
the rearrangement unit executes the rearrangement by, with use of a storage device that is capable of temporarily storing signals that have been read out, selecting signals that are read out from the image sensor or signals that have been stored in the storage device, and writing the selected signals to a memory in an order of the arrangement of the pixels in the image sensor.

5. The image capture apparatus according to claim 4, wherein
writing and reading are executable at higher speed with the storage device than with the memory.

6. The image capture apparatus according to claim 1, wherein
the rearrangement unit executes the rearrangement based on a placement of the pixels used as the pixels for focus-detection in the image sensor.

7. The image capture apparatus according to claim 1, further comprising:
a generation unit configured to generate signals for focus-detection from the signals of the pixels used as the pixels for focus-detection; and
a focus detection unit configured to execute focus detection of an imaging optical system in the image capture apparatus based on the signals for focus-detection.

8. The image capture apparatus according to claim 1, wherein
the pixels include a plurality of photoelectric conversion unit,
with respect to the pixels used as the pixels for focus-detection, the readout unit reads out signals obtained by summing signals of the plurality of photoelectric conversion unit and signals of a part of the plurality of photoelectric conversion unit, and
the signals for the captured image that have been generated from the signals of the pixels used as the pixels for focus-detection are the signals obtained by summing.

9. The image capture apparatus according to claim 8, wherein
with respect to the pixels used as the pixels for image-capturing, the readout unit reads out the signals obtained by summing the signals of the plurality of photoelectric conversion unit.

10. A control method for an image capture apparatus having an image sensor including a plurality of pixels that are usable both as pixels for image-capturing and pixels for focus-detection, the control method comprising:
reading out signals of pixels used as the pixels for focus-detection from among the plurality of pixels;
reading out signals of pixels used as the pixels for image-capturing after reading out the signals of the pixels used as the pixels for focus-detection; and
rearranging signals for a captured image that have been generated from the signals of the pixels used as the pixels for focus-detection, as well as signals that have been read out from the pixels used as the pixels for image-capturing, into an order that is the same as an arrangement of the pixels in the image sensor.

11. A computer-readable medium having stored therein a program that causes a computer included in an image capture apparatus that comprises an image sensor including a plurality of pixels that are usable both as pixels for image-capturing and pixels for focus-detection to function as:
a readout unit configured to read out signals of pixels used as the pixels for focus-detection and then reading out signals of pixels used as the pixels for image-capturing from among the plurality of pixels; and
a rearrangement unit configured to rearrange signals for a captured image that have been generated from the signals of the pixels used as the pixels for focus-detection, as well as signals that have been read out from the pixels used as the pixels for image-capturing, into an order that is the same as an arrangement of the pixels in the image sensor.
